(19) United States
(12) Patent Application Publication
(10) Pub. No.: US 2026/0021692 A1
(43) Pub. Date: Jan. 22, 2026

(54) Embedded hard cover

(71) Applicant: Yunyan He, Hangzhou (CN)

(72) Inventors: Shaoyong Zheng, Hangzhou (CN); Yunyan He, Hangzhou (CN)

(21) Appl. No.: 19/014,714

(22) Filed: Jan. 9, 2025

(30) Foreign Application Priority Data
Jul. 19, 2024 (CN) 202410972075.X

(51) Int. Cl. B60J 7/14

(52) U.S. Cl. CPC B60J 7/141

(57) ABSTRACT

The present invention discloses an embedded hard cover, comprises rotating shaft, edge strip, guide rail system, clip system, multiple plate bodies; the multiple plate bodies are connected by the rotating shaft; the edge strip is connected to both ends of the rotating shaft and the plate body, the rotating shaft, the plate body, the edge strip form the main body of the lid; the guide rail system is used to support the cover body, and the clip system is used to fix the guide rail system on the car body, the guide rail system includes a guide rail, the guide rail upper plane and the guide rail lower plane; the front plate comprises a front plate side rail, which is provided with a support edge supported on a flat surface of the guide rail, a gap between the front panel side rail and the lower surface of the guide rail.

### CROSS REFERENCE TO RELATED APPLICATION

This application claims priority benefit of Chinese patent Application No. 202410972075.X, filed on Jul. 19, 2024, and the entire contents of which are incorporated herein by reference.

### TECHNICAL FIELD

The present invention belongs to the field of pickup truck covers and specifically relates to an embedded hard cover.

### BACKGROUND TECHNOLOGY

Pickup trucks are an important component of the automotive market. Pickup trucks are a type of vehicle that uses a sedan front and driver's cab, as well as an open truck compartment. They are characterized by both sedan like comfort and strong power, and are even more capable of carrying goods and adapting to poor road conditions than sedans. The most common pickup truck model is a double row pickup truck, which can be used as a dedicated vehicle, multi-purpose vehicle, official vehicle, and business vehicle, as well as a household vehicle for carrying goods, traveling, and renting. The so-called “pickup truck” is a hybrid of sedan and truck. With the expansion of the scale of modification enthusiasts, pickup truck modification has become an increasingly popular category among modification enthusiasts.

The existing pickup truck covers are divided into soft covers and hard covers. For hard covers, the front bumper is usually difficult to open, making it difficult to fully open the hard pickup truck cover.

### SUMMARY OF THE INVENTION

In order to solve the above-mentioned problems in the existing technology, the technical solution adopted by the present invention is:
An embedded hard cover comprising a rotating shaft, edge rubber strip, guide rail system, clip system, and multiple plate bodies;
The multiple plates are connected by a rotating shaft;
The edge adhesive strip is connected to both ends of the rotating shaft and the plate body, and the rotating shaft, the plate body, and the edge adhesive strip form the main body of the lid;
The guide rail system is used to support the cover body, and the clip system is used to fix the guide rail system on the vehicle body. The guide rail system includes a guide rail, which has a guide rail upper plane and a guide rail lower plane;
The front panel comprises a front panel side rail, which is provided with a support edge supported on a flat surface of the guide rail. There is a gap between the front panel side rail and the lower surface of the guide rail.

The plate body comprises a front plate, a middle plate, and a rear plate.

An embedded hard cover, comprises rotating shaft, front plate, middle plate, rear plate, edge strip, guide rail system, and clip system;
The rotating shaft comprises a first soft rotating shaft and a second soft rotating shaft, wherein the first soft rotating shaft and the second soft rotating shaft have the same width, and the rotating shaft is made of flexible material or a combination of flexible material and hard material;
The front plate and the middle plate are connected by the second soft rotating shaft, and the middle plate and the rear plate are connected by the first soft rotating shaft;
The edge strip is connected to both ends of the rotating shaft, front plate, middle plate, and rear plate, and the rotating shaft, front plate, middle plate, rear plate, and edge strip form the main body of the lid;
The guide rail system is used to support the cover body, and the clip system is used to fix the guide rail system on the car body. The guide rail system includes a guide rail, which is provided with a guide rail upper plane and a guide rail lower plane;
The front plate comprises a front panel side rail, a front panel lock, and a front panel fixed square head rod. The front panel side rail is provided with a support edge, which is supported on the guide rail upper plane of the guide rail. There is a gap between the front panel side rail and the guide rail lower plane of the guide rail. The front panel lock is located on the side of the front plate near the front of the vehicle, and the front panel fixed square head rod is located on the side of the front plate near the rear of the car.

An embedded hard cover, comprises rotating shaft, front plate, middle plate, rear plate, edge strip, guide rail system, and clip system;
The rotating shaft comprises the first soft rotating shaft and the second soft rotating shaft, wherein one of the first soft rotating shaft and the second soft rotating shaft is wider and the other is narrower, and the rotating shaft is made of flexible material or a combination of flexible material and hard material;
The front plate and the middle plate are connected by the second soft rotating shaft, and the middle plate and the rear plate are connected by the first soft rotating shaft;
The edge strip is connected to both ends of the rotating shaft, front plate, middle plate, and rear plate, and the rotating shaft, front plate, middle plate, rear plate, and edge strip form the main body of the lid;
The guide rail system is used to support the cover body, and the clip system is used to fix the guide rail system on the car body. The guide rail system includes a guide rail, which is provided with a guide rail upper plane and a guide rail lower plane;
The front plate comprises a front panel side rail, a front panel lock, and a front panel fixed square head rod. The front panel side rail is provided with a support edge, which is supported on the guide rail upper plane of the guide rail. There is a gap between the front panel side rail and the guide rail lower plane of the guide rail. The front panel lock is located on the side of the front plate near the front of the vehicle, and the front panel fixed square head rod is located on the side of the front plate near the rear of the car.

An embedded hard cover, comprises rotating shaft, front plate, middle plate, rear plate, edge strip, guide rail system, and clip system;
The rotating shaft comprises the first soft rotating shaft and the second soft rotating shaft, wherein the first soft rotating shaft and the second soft rotating shaft have the same width, and the rotating shaft is made of flexible material or a combination of flexible material and hard material;
The front plate and the middle plate are connected by a second soft rotating shaft, and the middle plate and the rear plate are connected by a first soft rotating shaft;
The edge strip is connected to both ends of the rotating shaft, front plate, middle plate, and rear plate, and the rotating shaft, front plate, middle plate, rear plate, and edge strip form the main body of the lid;
The guide rail system is used to support the cover body, and the clip system is used to fix the guide rail system on the vehicle body. The guide rail system includes a guide rail, which is provided with a guide rail upper plane and a guide rail lower plane;
The front plate comprises a front panel side rail, a front panel lock, and a front panel fixed square head rod. The front panel side rail is provided with a support edge, which is supported on the guide rail upper plane of the guide rail. There is a gap between the front panel side rail and the guide rail lower plane of the guide rail. The front panel lock is located on the side of the front plate near the rear of the vehicle, and the front panel fixed square head rod is located on the side of the front plate near the front of the vehicle.

An embedded hard cover, comprises rotating shaft, front plate, middle plate, rear plate, edge strip, guide rail system, and clip system;
The rotating shaft comprises a first soft rotating shaft and a second soft rotating shaft, wherein one of the first soft rotating shaft and the second soft rotating shaft is wider and the other is narrower, and the rotating shaft is made of flexible material or a combination of flexible material and hard material;
The front plate and the middle plate are connected by a second soft rotating shaft, and the middle plate and the rear plate are connected by a first flexible shaft;
The edge strip is connected to both ends of the rotating shaft, front plate, middle plate, and rear plate, and the rotating shaft, front plate, middle plate, rear plate, and edge strip form the main body of the lid;
The guide rail system is used to support the cover body, and the clip system is used to fix the guide rail system on the vehicle body. The guide rail system includes a guide rail, which is provided with a guide rail upper plane and a guide rail lower plane;
The front plate comprises a front panel side rail, a front panel lock, and a front panel fixed square head rod. The front panel side rail is provided with a support edge, which is supported on the guide rail upper plane of the guide rail. There is a gap between the front panel side rail and the guide rail lower plane of the guide rail. The front panel lock is located on the side of the front plate near the rear of the vehicle, and the front panel fixed square head rod is located on the side of the front plate near the front of the vehicle.

Furthermore, the front plate is provided with a large front rail, which is provided with a locking groove, and the steel wire support block includes a first steel wire support block and a second steel wire support block, both of which are connected to the locking groove, and the front plate steel wire is located between the first steel wire support block and the second steel wire support block.

The fixing block crossbar is used to place the front plate locking handle through the handle fixing block;
The front panel is equipped with a front panel steel wire channel, and the front plate steel wire passes through the front panel steel wire channel;
The two ends of the front rail steel wire are respectively connected to a front panel lock.

Furthermore, the guide rail system comprises a first guide rail and a second guide rail. The first guide rail and the second guide rail are connected by a first clip assembly, and the joint between the first guide rail and the second guide rail is coated with sealant.

Furthermore, the middle plate is provided with a plastic buckle, which includes an inclined protrusion block and a fixed base;
The guide rail system comprises a guide rail plastic hook block, which includes a horizontal plate, a vertical plate, and a positioning hole;
The inclined protrusion block is used to cooperate with the horizontal plate. The plastic buckle is connected to the middle plate through the fixed screw hole on the fixed base. The guide rail plastic hook block is positioned with the guide rail through a positioning hole provided on the vertical plate. The vertical plate and the horizontal plate are connected as a vertical load-bearing support structure.

When the car cover is flipped over, the slanted protrusion block freely engages with the horizontal plate.

Furthermore, the front side panel is equipped with a first protrusion, a second protrusion, and a cavity;
The edge strip is provided with a left and a right contact portion, which extend into the cavity. The left contact portion is in contact with the first protrusion, and the right contact portion cooperates with the second protrusion. The cavity is used for sliding the right contact portion. There is a gap between the front panel side rail and the lower plane of the guide rail, and a guide rail waterproof strip is provided in the gap. The guide rail waterproof strip is connected to the lower plane of the guide rail.

The lower plane of the guide rail is provided with a lower plane convex line, which is used to locate the waterproof strip of the guide rail.

Ensure that the waterproof strip of the guide rail can be attached straight, so that a drainage channel is formed between the guide rail and the waterproof strip of the guide rail.

Furthermore, the front panel is equipped with a front panel fixed square head rod, which includes a front panel fixed square head and a front panel fixed plum blossom nut;
The front plate fixing square head is connected to the rear rail of the front plate, and the front plate fixing square head passes through the second clamp component. The front plate fixing square head is provided with a front plate fixing square head thread, and the front plate fixing plum blossom nut is connected to the front plate fixing square head thread.

Furthermore, the front panel is equipped with a large front rail, which is equipped with a front panel pad and a front card buckle. The front panel pad is used to support the main body of the car cover.

The thickness of the front, middle, and rear plates shall not exceed 30 MM.

The beneficial effects of the present invention are: by improving the overall hood, on the one hand, the joint structure of the rotating shaft is eliminated, so that the plate body and the rotating shaft are in direct contact with the edge rubber strip, which not only simplifies the structure but also improves the waterproof effect.

### ATTACHED IMAGE DESCRIPTION

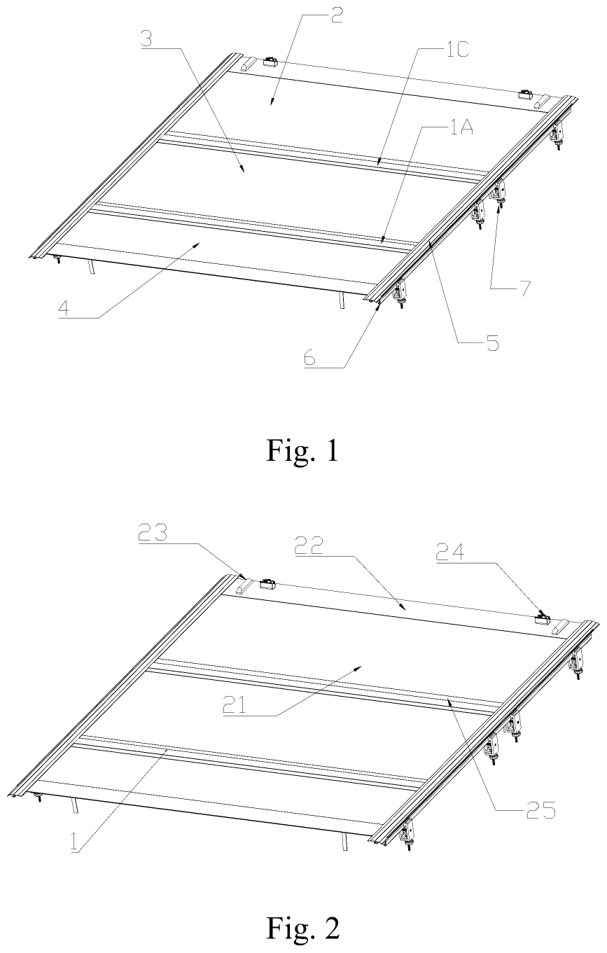

FIG. 1 is a schematic diagram of the structure of the present invention.

FIG. 2 is a schematic diagram of the structure of the present invention.

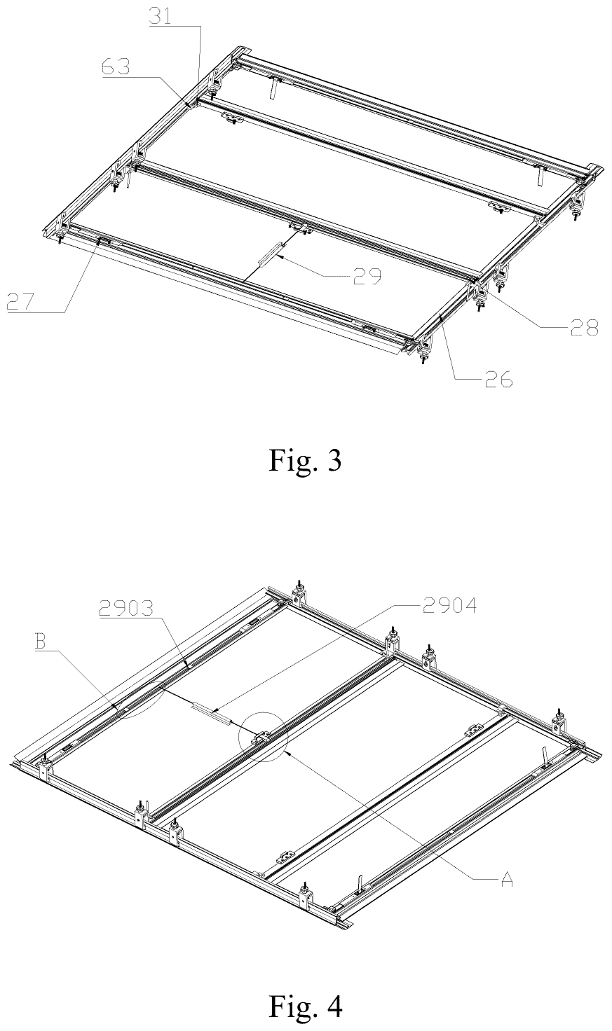

FIG. 3 is a schematic diagram of the structure of the present invention.

FIG. 4 is a schematic diagram of the structure of the present invention.

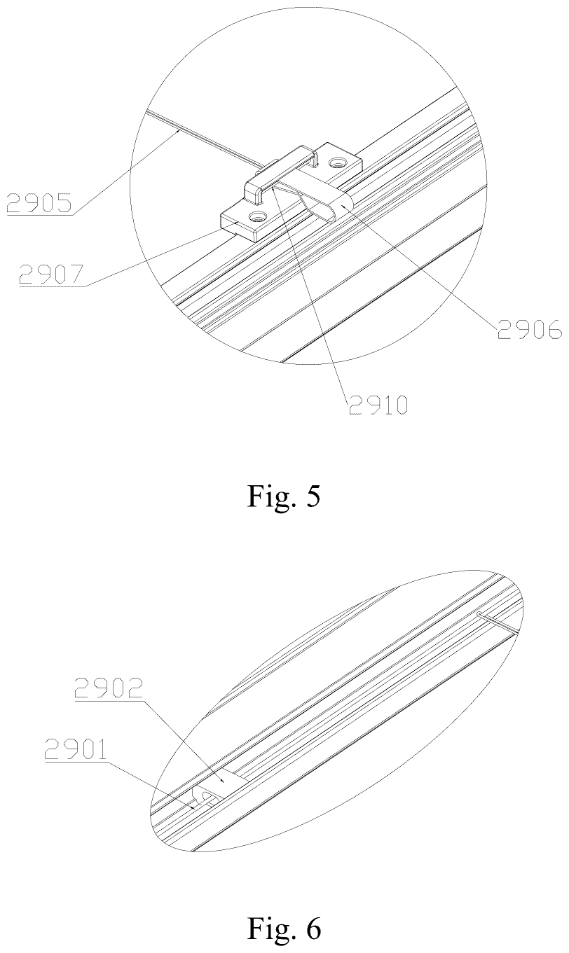

FIG. 5 is an enlarged partial view of part A in FIG. 4.

FIG. 6 is an enlarged partial view of part B in FIG. 4.

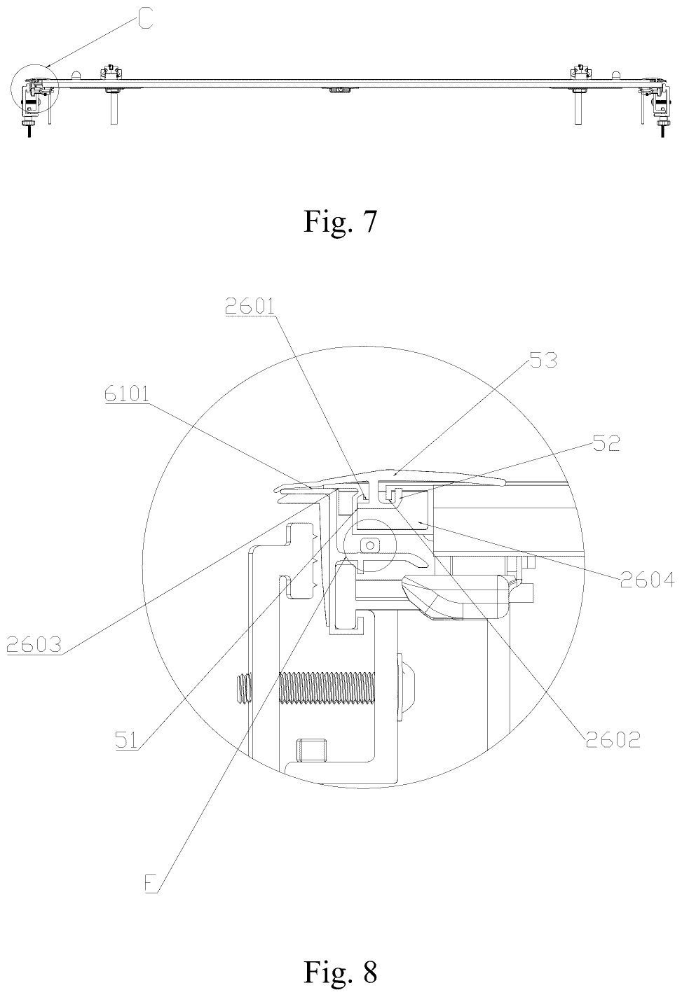

FIG. 7 is the fifth schematic diagram of the structure of the present invention.

FIG. 8 is an enlarged partial view of part C in FIG. 7.

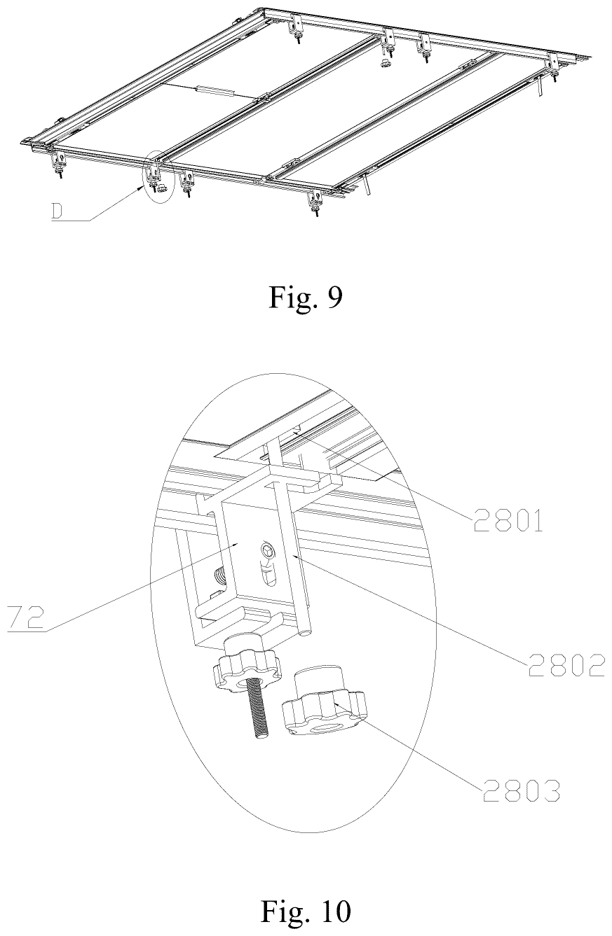

FIG. 9 is schematic diagram six of the structure of the present invention.

FIG. 10 is an enlarged partial view of section D in FIG. 9.

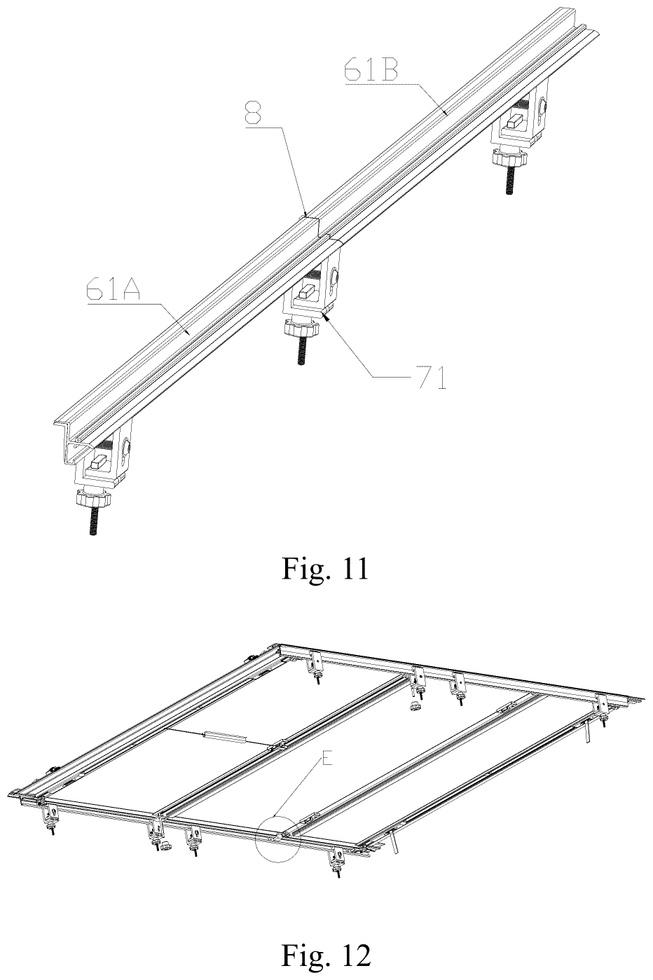

FIG. 11 is a schematic diagram of the connection of the guide rail.

FIG. 12 is schematic diagram seven of the structure of the present invention.

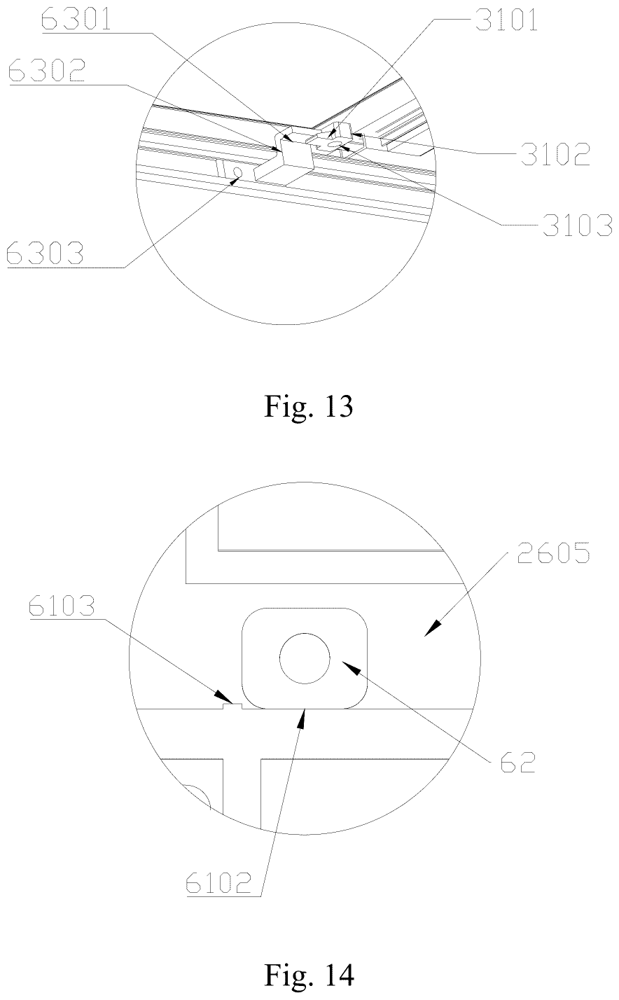

FIG. 13 is an enlarged partial view of section E in FIG. 12.

FIG. 14 is an enlarged partial view of section F in FIG. 8.

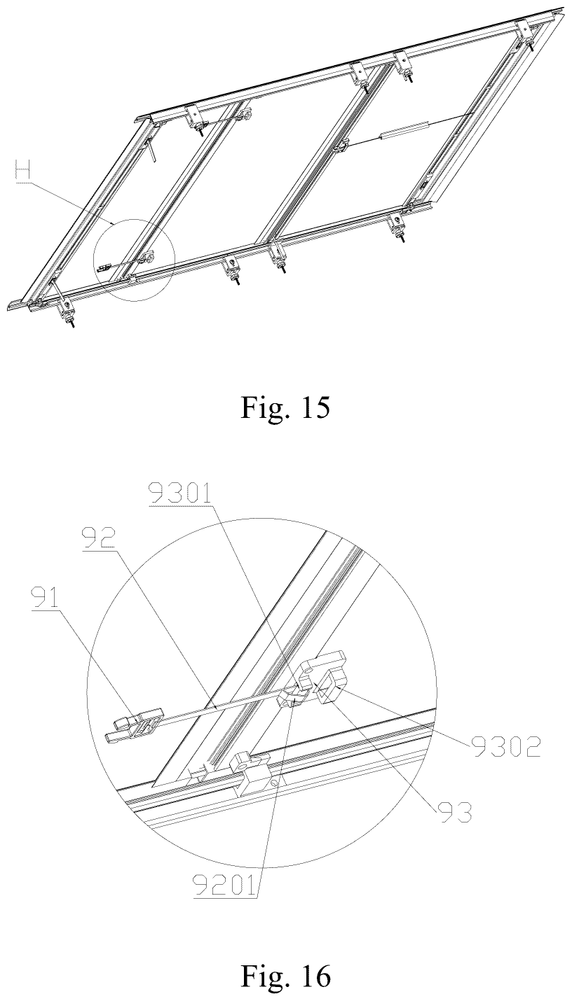

FIG. 15 is a schematic diagram of the installation of the buckle in the present invention.

FIG. 16 is an enlarged partial view of the H section in FIG. 15.

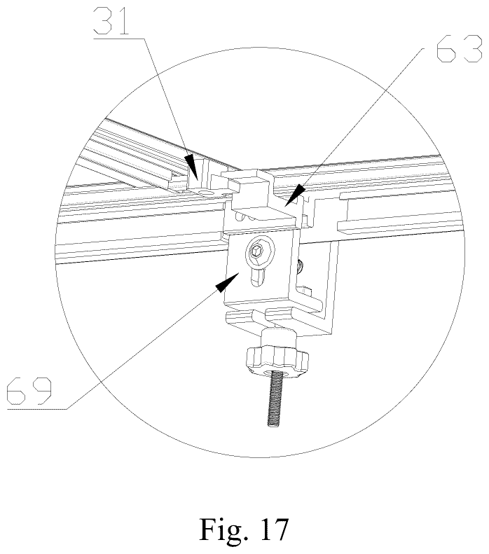

FIG. 17 is a schematic diagram of the connection of the sidebar clip in the present invention.

In the figure: 1—Rotating shaft; 1A—First soft shaft; 1C—Second soft rotating shaft; 2—Front plate; 21—Front panel; 22—Large front rail; 23—Front large plate pad; 24—Front plate buckle; 25—Front panel and rear panel; 26—Front panel side rail; 2601—First protrusion; 2602—Second protrusion; 2603—Support edge; 2604—Cavity; 2605—Gap; 27—Front panel lock; 28—Front panel fixed square head rod; 2801—Front plate fixing square head; 2802—Front panel fixed square head thread; 2803—Front plate fixed plum blossom nut; 29—Front panel unlocking mechanism; 2901—Front rail steel wire; 2902—Steel wire first support block; 2093—Steel wire second support block; 2094—Front plate steel wire channel; 2905—Front plate steel wire; 2906—Front plate locking handle; 2907—Handle fixing block; 2910—Fixing block crossbar; 3—Middle plate; 31—Plastic buckle; 3101—Inclined protrusion block; 3102—Fixed base; 3103—Fixed screw hole 4—Rear plate; 5—Edge strip; 51—Left contact part; 52—Right contact part; 53—Upper covering section; 6—Guide rail system; 61A—First guide rail; 61B—Second guide rail; 6101—Guide rail upper plane; 6102—Guide rail lower plane; 6103—lower plane convex line; 62—Waterproof strip for guide rail; 63—Guide rail plastic hook block; 6301—Horizontal plate; 6302—Vertical Plate; 6303—Positioning hole; 69—Side rail clip; 7—Clip system; 71—First clip component; 72—Second clip component; 8—Sealant; 91—Buckle; 92—Webbing; 9201—Ribbon binding ring; 93—Buckle seat; 9301—Fixed binding rod; 9302—Buckle fixing port.

### SPECIFIC IMPLEMENTATION METHOD

The present invention will be further explained in conjunction with the accompanying drawings and reference numerals.

In order to better understand the above objectives, features, and advantages of the present invention, the present invention will be described in detail below in conjunction with the accompanying drawings and specific embodiments. It should be noted that, without conflict, the embodiments and features of the present application can be combined with each other.

The terms ‘first’, ‘second’, ‘third’, etc. are only used to distinguish descriptions and cannot be understood as indicating or implying relative importance.

In the description of the present invention, it should be noted that unless otherwise specified and limited, the terms “setting”, “installation”, “connection”, and “connection” should be broadly understood, for example, they can be fixed connections, detachable connections, or integral connections; It can be a mechanical connection or an electrical connection; It can be directly connected, indirectly connected through an intermediate medium, or connected internally between two components.

For ordinary technical personnel in this field, the specific meanings of the above terms in the present invention can be understood in specific situations.

The specific embodiments of the present invention will be described in detail below in conjunction with the accompanying drawings.

It should be understood that the specific embodiments described herein are only for illustrating and explaining the present invention, and are not intended to limit the present invention.

### Example 1

As shown in FIGS. 1, 2, 7, 8, and 14, an embedded hard cover comprises a rotating shaft 1, an edge adhesive strip 5, a guide rail system 6, a clip system 7, and multiple plate bodies;
The multiple plates are connected by a rotating shaft 1;
The edge adhesive strip 5 is connected to both ends of the rotating shaft 1 and the plate body, and the rotating shaft 1, the plate body, and the edge adhesive strip 5 form the main body of the lid;
The guide rail system 6 is used to support the cover body, and the clip system 7 is used to fix the guide rail system 6 on the vehicle body. The guide rail system 6 includes a guide rail, which is provided with a guide rail upper plane 6101 and a guide rail lower plane 6102;
The front panel 2 includes a front panel side rail 26, which is provided with a support edge 2603. The support edge 2603 is supported on the upper plane 6101 of the guide rail, and there is a gap 2605 between the front panel side rail 26 and the lower plane 6102 of the guide rail.

The plate body includes a front plate 2, a middle plate 3, and a rear plate 4.

### Example 2

As shown in FIGS. 1, 2, 7, 8, and 14, an embedded hard cover, comprises rotating shaft 1, front plate 2, middle plate 3, rear plate 4, edge strip 5, guide rail system 6, and clip system 7;
The rotating shaft 1 comprises a first soft rotating shaft 1A and a second soft rotating shaft 1C, wherein the first soft rotating shaft 1A and the second soft rotating shaft 1C have the same width, and the rotating shaft 1 is made of flexible material or a combination of flexible material and hard material;
The front plate 2 and the middle plate 3 are connected by the second soft rotating shaft 1C, and the middle plate 3 and the rear plate 4 are connected by the first soft rotating shaft 1A;
The edge strip 5 is connected to both ends of the rotating shaft 1, front plate 2, middle plate 3, and rear plate 4, and the rotating shaft 1, front plate 2, middle plate 3, rear plate 4, and edge strip 5 form the main body of the lid;
The guide rail system 6 is used to support the cover body, and the clip system 7 is used to fix the guide rail system 6 on the car body. The guide rail system 6 includes a guide rail, which is provided with a guide rail upper plane 6101 and a guide rail lower plane 6102;
The front plate 2 comprises a front panel side rail 26, a front panel lock 27, and a front panel fixed square head rod 28. The front panel side rail 26 is provided with a support edge 2603, which is supported on the guide rail upper plane 6101 of the guide rail. There is a gap 2605 between the front panel side rail 26 and the guide rail lower plane 6102 of the guide rail. The front panel lock 27 is located on the side of the front plate 2 near the front of the vehicle, and the front panel fixed square head rod 28 is located on the side of the front plate 2 near the rear of the car. Only when it is necessary to completely remove the car cover will the front panel fixed square head rod 28 be opened.

### Example 3

As shown in FIGS. 1, 2, 7, 8, and 14, an embedded hard cover, comprises rotating shaft 1, front plate 2, middle plate 3, rear plate 4, edge strip 5, guide rail system 6, and clip system 7;
The rotating shaft 1 comprises the first soft rotating shaft 1A and the second soft rotating shaft 1C, wherein one of the first soft rotating shaft 1A and the second soft rotating shaft 1C is wider and the other is narrower, and the rotating shaft 1 is made of flexible material or a combination of flexible material and hard material;
The front plate 2 and the middle plate 3 are connected by the second soft rotating shaft 1C, and the middle plate 3 and the rear plate 4 are connected by the first soft rotating shaft 1A;
The edge strip 5 is connected to both ends of the rotating shaft 1, front plate 2, middle plate 3, and rear plate 4, and the rotating shaft 1, front plate 2, middle plate 3, rear plate 4, and edge strip 5 form the main body of the lid;
The guide rail system 6 is used to support the cover body, and the clip system 7 is used to fix the guide rail system 6 on the car body. The guide rail system 6 includes a guide rail, which is provided with a guide rail upper plane 6101 and a guide rail lower plane 6102;
The front plate 2 comprises a front panel side rail 26, a front panel lock 27, and a front panel fixed square head rod 28. The front panel side rail 26 is provided with a support edge 2603, which is supported on the guide rail upper plane 6101 of the guide rail. There is a gap 2605 between the front panel side rail 26 and the guide rail lower plane 6102 of the guide rail. The front panel lock 27 is located on the side of the front plate 2 near the front of the vehicle, and the front panel fixed square head rod 28 is located on the side of the front plate 2 near the rear of the car.

### Example 4

As shown in FIGS. 1, 2, 7, 8, and 14, an embedded hard cover, comprises rotating shaft 1, front plate 2, middle plate 3, rear plate 4, edge strip 5, guide rail system 6, and clip system 7;
The rotating shaft 1 comprises the first soft rotating shaft 1A and the second soft rotating shaft 1C, wherein the first soft rotating shaft 1A and the second soft rotating shaft 1C have the same width, and the rotating shaft 1 is made of flexible material or a combination of flexible material and hard material;
The front plate 2 and the middle plate 3 are connected by a second soft rotating shaft 1C, and the middle plate 3 and the rear plate 4 are connected by a first soft rotating shaft 1A;
The edge strip 5 is connected to both ends of the rotating shaft 1, front plate 2, middle plate 3, and rear plate 4, and the rotating shaft 1, front plate 2, middle plate 3, rear plate 4, and edge strip 5 form the main body of the lid;
The guide rail system 6 is used to support the cover body, and the clip system 7 is used to fix the guide rail system 6 on the vehicle body. The guide rail system 6 includes a guide rail, which is provided with a guide rail upper plane 6101 and a guide rail lower plane 6102;
The front plate 2 comprises a front panel side rail 26, a front panel lock 27, and a front panel fixed square head rod 28. The front panel side rail 26 is provided with a support edge 2603, which is supported on the guide rail upper plane 6101 of the guide rail. There is a gap 2605 between the front panel side rail 26 and the guide rail lower plane 6102 of the guide rail. The front panel lock 27 is located on the side of the front plate 2 near the rear of the vehicle, and the front panel fixed square head rod 28 is located on the side of the front plate 2 near the front of the vehicle.

### Example 5

As shown in FIGS. 1, 2, 7, 8, and 14, an embedded hard cover, comprises rotating shaft 1, front plate 2, middle plate 3, rear plate 4, edge strip 5, guide rail system 6, and clip system 7;
The rotating shaft 1 comprises a first soft rotating shaft 1A and a second soft rotating shaft 1C, wherein one of the first soft rotating shaft 1A and the second soft rotating shaft 1C is wider and the other is narrower, and the rotating shaft 1 is made of flexible material or a combination of flexible material and hard material;
The front plate 2 and the middle plate 3 are connected by a second soft rotating shaft 1C, and the middle plate 3 and the rear plate 4 are connected by a first flexible shaft 1A;
The edge strip 5 is connected to both ends of the rotating shaft 1, front plate 2, middle plate 3, and rear plate 4, and the rotating shaft 1, front plate 2, middle plate 3, rear plate 4, and edge strip 5 form the main body of the lid;
The guide rail system 6 is used to support the cover body, and the clip system 7 is used to fix the guide rail system 6 on the vehicle body. The guide rail system 6 includes a guide rail, which is provided with a guide rail upper plane 6101 and a guide rail lower plane 6102;
The front plate 2 comprises a front panel side rail 26, a front panel lock 27, and a front panel fixed square head rod 28. The front panel side rail 26 is provided with a support edge 2603, which is supported on the guide rail upper plane 6101 of the guide rail. There is a gap 2605 between the front panel side rail 26 and the guide rail lower plane 6102 of the guide rail. The front panel lock 27 is located on the side of the front plate 2 near the rear of the vehicle, and the front panel fixed square head rod 28 is located on the side of the front plate 2 near the front of the vehicle.

### Example 6

On the basis of claims 1 and 2, as shown in FIGS. 3-6, the cover body is connected to a front plate unlocking mechanism 29, and the front plate unlocking mechanism 29 comprises a front rail steel wire 2901, a steel wire support block, a front plate steel wire 2905, a front plate locking handle 2906, and a handle fixing block 2907;
The front plate 2 is connected to a steel wire support block, and the front rail steel wire 2901 passes through the steel wire support block and is connected to a front panel lock 27;
The handle fixing block 2907 is connected to the front panel and rear rail 25, and the handle fixing block 2907 is equipped with a fixing block crossbar 2910;
One end of the front plate steel wire 2905 is connected to the front rail steel wire 2901, and the other end of the front plate steel wire 2905 is connected to the front plate locking handle 2906, which passes through the fixed block crossbar 2910.

### Example 7

On the basis of Example 6, the fixing block crossbar 2910 is used to place the front plate locking handle 2906 through the handle fixing block 2907;
The front panel 21 is equipped with a front panel steel wire channel 2094, and the front plate steel wire 2905 passes through the front panel steel wire channel 2094;
The two ends of the front rail steel wire 2901 are respectively connected to a front panel lock 27.

### Example 8

On the basis of embodiments 2-5, as shown in FIG. 11, the guide rail system 6 comprises a first guide rail 61A and a second guide rail 61B, the first guide rail 61A and the second guide rail 61B are connected by a first clip assembly 71, and the joint between the first guide rail 61A and the second guide rail 61B is coated with sealant 8.

### Example 9

On the basis of embodiments 2-5, as shown in FIGS. 12 and 13, the middle plate 3 is provided with a plastic buckle 31, which includes an inclined protrusion block 3101 and a fixed base 3102;
The guide rail system 6 comprises a guide rail plastic hook block 63, which includes a horizontal plate 6301, a vertical plate 6302, and a positioning hole 6303;
The inclined protrusion block 3101 is used to cooperate with the horizontal plate 6301, and the plastic buckle 31 is connected to the middle plate 3 through the fixed screw hole 3103 on the fixed base 3102. The guide rail plastic hook block 63 is positioned with the guide rail through the positioning hole 6303 provided on the vertical plate 6302, and the vertical plate 6302 and the horizontal plate 6301 are connected as a vertical load-bearing support structure.

When the car cover is flipped over, the inclined protrusion block 3101 freely engages with the horizontal plate 6301.

### Example 10

On the basis of implementing examples 2-5, the front panel side rail 26 is provided with a first protrusion 2601, a second protrusion 2602, and a cavity 2604;
The edge strip 5 is provided with a left contact part 51 and a right contact part 52, which extend into the cavity 2604. The left contact part 51 contacts the first protrusion 2601, and the right contact part 52 cooperates with the second protrusion 2602. The cavity 2604 is used for the right contact part 52 to slide. There is a gap 2605 between the front panel side rail 26 and the lower plane of the guide rail lower plane 6102, and a guide rail waterproof strip 62 is provided in the gap 2605. The guide rail waterproof strip 62 is connected to the guide rail lower plane 6102.

The edge adhesive strip 5 is also provided with an upper covering portion 53, which covers the upper side of the guide rail system 6.

The guide rail lower plane 6102 of the guide rail is provided with a lower plane convex line 6103, and the lower plane convex line 6103 is used to position the waterproof strip 62 of the guide rail.

Ensure that the waterproof strip 62 of the guide rail can be attached straight, so that a drainage channel is formed between the guide rail and the waterproof strip 62 of the guide rail.

### Example 11

On the basis of embodiments 2-5, as shown in FIGS. 9 and 10, the front plate 2 is provided with a front panel fixed square head rod 28, and the front panel fixed square head rod 28 comprises a front plate fixing square head 2801 and a front plate fixing plum blossom nut 2803;
The front plate fixing square head 2801 is connected to the front plate rear rail 25, and the front plate fixing square head 2801 passes through the second clip assembly 72. The front plate fixing square head 2801 is provided with a front plate fixing square head thread 2802, and the front plate fixing plum blossom nut 2803 is connected to the front plate fixing square head thread 2802.

### Example 12

On the basis of implementing examples 2-5, the front plate 2 is provided with a large front rail 22, and the large front rail 22 is provided with a front large plate pad 23 and a front plate buckle 24, and the front large plate pad 23 is used to support the main body of the car cover.

The thickness of the front plate 2, middle plate 3, and rear plate 4 shall not exceed 30 MM.

### Example 13

On the basis of embodiments 2-5, it also includes a buckle component, a buckle component, which comprises a buckle 91, a webbing 92, and a buckle seat 93. One end of the webbing 92 is connected to the buckle 91, and the other end of the webbing 92 is provided with a webbing binding ring 9201. The buckle seat 93 is connected to the plate body or the rotating shaft 1, and is provided with a fixed binding rod 9301 and a buckle fixing port 9302. The webbing binding ring 9201 is connected to the fixed binding rod 9301, and the buckle seat 93 is provided with a fixed binding rod 9301 and a buckle fixing port 9302. The buckle fixing port 9302 is compatible with the buckle 91.

The rotational fit here refers to the plastic hook block 63 of the guide rail being stuck on the side rail clip 69 with the rotation of the shaft during the process of closing the car cover.

The present invention is not limited to the above optional embodiments, and anyone can derive various forms of products from the inspiration of the present invention. However, regardless of any changes in its shape or structure, any technical solution that falls within the scope of the claims of the present invention is within the scope of protection of the present invention.

1. An embedded hard cover, characterized by: comprises rotating shaft (1), front plate (2), middle plate (3), rear plate (4), edge strip (5), guide rail system (6), and clip system (7);
The rotating shaft (1) comprises a first soft rotating shaft (1A) and a second soft rotating shaft (1C), wherein the first soft rotating shaft (1A) and the second soft rotating shaft (1C) have the same width, and the rotating shaft (1) is made of flexible material or a combination of flexible material and hard material;
The front plate (2) and the middle plate (3) are connected by the second soft rotating shaft (1C), and the middle plate (3) and the rear plate (4) are connected by the first soft rotating shaft (1A);
The edge strip (5) is connected to both ends of the rotating shaft (1), front plate (2), middle plate (3), and rear plate (4), and the rotating shaft (1), front plate (2), middle plate (3), rear plate (4), and edge strip (5) form the main body of the lid;
The guide rail system (6) is used to support the cover body, and the clip system (7) is used to fix the guide rail system (6) on the car body. The guide rail system (6) includes a guide rail, which is provided with a guide rail upper plane (6101) and a guide rail lower plane (6102);
The front plate (2) comprises a front panel side rail (26), a front panel lock (27), and a front panel fixed square head rod (28). The front panel side rail (26) is provided with a support edge (2603), which is supported on the guide rail upper plane (6101) of the guide rail. There is a gap (2605) between the front panel side rail (26) and the guide rail lower plane (6102) of the guide rail. The front panel lock (27) is located on the side of the front plate (2) near the front of the vehicle, and the front panel fixed square head rod (28) is located on the side of the front plate (2) near the rear of the car.

2. An embedded hard cover, characterized by: comprises rotating shaft (1), front plate (2), middle plate (3), rear plate (4), edge strip (5), guide rail system (6), and clip system (7);
The rotating shaft (1) comprises the first soft rotating shaft (1A) and the second soft rotating shaft (1C), wherein one of the first soft rotating shaft (1A) and the second soft rotating shaft (1C) is wider and the other is narrower, and the rotating shaft (1) is made of flexible material or a combination of flexible material and hard material;
The front plate (2) and the middle plate (3) are connected by the second soft rotating shaft (1C), and the middle plate (3) and the rear plate (4) are connected by the first soft rotating shaft (1A);
The edge strip (5) is connected to both ends of the rotating shaft (1), front plate (2), middle plate (3), and rear plate (4), and the rotating shaft (1), front plate (2), middle plate (3), rear plate (4), and edge strip (5) form the main body of the lid;
The guide rail system (6) is used to support the cover body, and the clip system (7) is used to fix the guide rail system (6) on the car body. The guide rail system (6) includes a guide rail, which is provided with a guide rail upper plane (6101) and a guide rail lower plane (6102);
The front plate (2) comprises a front panel side rail (26), a front panel lock (27), and a front panel fixed square head rod (28). The front panel side rail (26) is provided with a support edge (2603), which is supported on the guide rail upper plane (6101) of the guide rail. There is a gap (2605) between the front panel side rail (26) and the guide rail lower plane (6102) of the guide rail. The front panel lock (27) is located on the side of the front plate (2) near the front of the vehicle, and the front panel fixed square head rod (28) is located on the side of the front plate (2) near the rear of the car.

3. The embedded hard cover according to claim 1 or 2, characterized in that: the cover body is connected to a front plate unlocking mechanism (29), and the front plate unlocking mechanism (29) comprises a front rail steel wire (2901), a steel wire support block, a front plate steel wire (2905), a front plate locking handle (2906), and a handle fixing block (2907);
The front plate (2) is connected to a steel wire support block, and the front rail steel wire (2901) passes through the steel wire support block and is connected to a front panel lock (27);
The handle fixing block (2907) is connected to the front panel and rear rail (25), and the handle fixing block (2907) is equipped with a fixing block crossbar (2910);
One end of the front plate steel wire (2905) is connected to the front rail steel wire (2901), and the other end of the front plate steel wire (2905) is connected to the front plate locking handle (2906), which passes through the fixed block crossbar (2910).

4. The embedded hard cover according to claim 3, characterized in that: the front plate (2) is provided with a large front rail (22), which is provided with a locking groove, and the steel wire support block includes a first steel wire support block (2902) and a second steel wire support block (2093), both of which are connected to the locking groove, and the front plate steel wire (2905) is located between the first steel wire support block (2902) and the second steel wire support block (2093).

5. The embedded hard cover according to claim 4, characterized in that the fixing block crossbar (2910) is used to place the front plate locking handle (2906) through the handle fixing block (2907);
The front panel (21) is equipped with a front panel steel wire channel (2094), and the front plate steel wire (2905) passes through the front panel steel wire channel (2094);
The two ends of the front rail steel wire (2901) are respectively connected to a front panel lock (27).

6. An embedded hard cover, characterized by: comprises rotating shaft (1), front plate (2), middle plate (3), rear plate (4), edge strip (5), guide rail system (6), and clip system (7);
The rotating shaft (1) comprises the first soft rotating shaft (1A) and the second soft rotating shaft (1C), wherein the first soft rotating shaft (1A) and the second soft rotating shaft (1C) have the same width, and the rotating shaft (1) is made of flexible material or a combination of flexible material and hard material;
The front plate (2) and the middle plate (3) are connected by a second soft rotating shaft (1C), and the middle plate (3) and the rear plate (4) are connected by a first soft rotating shaft (1A);
The edge strip (5) is connected to both ends of the rotating shaft (1), front plate (2), middle plate (3), and rear plate (4), and the rotating shaft (1), front plate (2), middle plate (3), rear plate (4), and edge strip (5) form the main body of the lid;
The guide rail system (6) is used to support the cover body, and the clip system (7) is used to fix the guide rail system (6) on the vehicle body. The guide rail system (6) includes a guide rail, which is provided with a guide rail upper plane (6101) and a guide rail lower plane (6102);
The front plate (2) comprises a front panel side rail (26), a front panel lock (27), and a front panel fixed square head rod (28). The front panel side rail (26) is provided with a support edge (2603), which is supported on the guide rail upper plane (6101) of the guide rail. There is a gap (2605) between the front panel side rail (26) and the guide rail lower plane (6102) of the guide rail. The front panel lock (27) is located on the side of the front plate (2) near the rear of the vehicle, and the front panel fixed square head rod (28) is located on the side of the front plate (2) near the front of the vehicle.

7. An embedded hard cover, characterized by: comprises rotating shaft (1), front plate (2), middle plate (3), rear plate (4), edge strip (5), guide rail system (6), and clip system (7);
The rotating shaft (1) comprises a first soft rotating shaft (1A) and a second soft rotating shaft (1C), wherein one of the first soft rotating shaft (1A) and the second soft rotating shaft (1C) is wider and the other is narrower, and the rotating shaft (1) is made of flexible material or a combination of flexible material and hard material;
The front plate (2) and the middle plate (3) are connected by a second soft rotating shaft (1C), and the middle plate (3) and the rear plate (4) are connected by a first flexible shaft (1A);
The edge strip (5) is connected to both ends of the rotating shaft (1), front plate (2), middle plate (3), and rear plate (4), and the rotating shaft (1), front plate (2), middle plate (3), rear plate (4), and edge strip (5) form the main body of the lid;
The guide rail system (6) is used to support the cover body, and the clip system (7) is used to fix the guide rail system (6) on the vehicle body. The guide rail system (6) includes a guide rail, which is provided with a guide rail upper plane (6101) and a guide rail lower plane (6102);
The front plate (2) comprises a front panel side rail (26), a front panel lock (27), and a front panel fixed square head rod (28). The front panel side rail (26) is provided with a support edge (2603), which is supported on the guide rail upper plane (6101) of the guide rail. There is a gap (2605) between the front panel side rail (26) and the guide rail lower plane (6102) of the guide rail. The front panel lock (27) is located on the side of the front plate (2) near the rear of the vehicle, and the front panel fixed square head rod (28) is located on the side of the front plate (2) near the front of the vehicle.

8. The embedded hard cover according to any one of claims 1, 2, 6, and 7, characterized in that: the guide rail system (6) comprises a first guide rail (61A) and a second guide rail (61B), the first guide rail (61A) and the second guide rail (61B) are connected by a first clip assembly (71), and the joint between the first guide rail (61A) and the second guide rail (61B) is coated with sealant (8).

9. The embedded hard cover according to claims 1, 2, 6, and 7, characterized in that: the middle plate (3) is provided with a plastic buckle (31), and the plastic buckle (31) comprises an inclined protrusion block (3101) and a fixed base (3102);
The guide rail system (6) comprises a guide rail plastic hook block (63), which includes a horizontal plate (6301), a vertical plate (6302), and a positioning hole (6303);
The inclined protrusion block (3101) is used to cooperate with the horizontal plate (6301), and the plastic buckle (31) is connected to the middle plate (3) through the fixed screw hole (3103) on the fixed base (3102). The guide rail plastic hook block (63) is positioned with the guide rail through the positioning hole (6303) provided on the vertical plate (6302), and the vertical plate (6302) and the horizontal plate (6301) are connected as a vertical load-bearing support structure.

10. The embedded hard cover according to claims 1, 2, 6, and 7, characterized in that the front panel side rail (26) is provided with a first protrusion (2601), a second protrusion (2602), and a cavity (2604);
The edge strip (5) is provided with a left contact part (51) and a right contact part (52), which extend into the cavity (2604). The left contact part (51) contacts the first protrusion (2601), and the right contact part (52) cooperates with the second protrusion (2602). The cavity (2604) is used for the right contact part (52) to slide. There is a gap (2605) between the front panel side rail (26) and the lower plane of the guide rail lower plane (6102), and a guide rail waterproof strip (62) is provided in the gap (2605). The guide rail waterproof strip (62) is connected to the guide rail lower plane (6102).

11. The embedded hard cover according to claim 10, characterized in that the guide rail lower plane (6102) of the guide rail is provided with a lower plane convex line (6103), and the lower plane convex line (6103) is used to position the waterproof strip (62) of the guide rail.

12. The embedded hard cover according to claims 1, 2, 6, and 7, characterized in that: the front plate (2) is provided with a front panel fixed square head rod (28), and the front panel fixed square head rod (28) comprises a front plate fixing square head (2801) and a front plate fixing plum blossom nut (2803);
The front plate fixing square head (2801) is connected to the front plate rear rail (25), and the front plate fixing square head (2801) passes through the second clip assembly (72). The front plate fixing square head (2801) is provided with a front plate fixing square head thread (2802), and the front plate fixing plum blossom nut (2803) is connected to the front plate fixing square head thread (2802).

13. The embedded hard cover according to claims 1, 2, 6, and 7, characterized in that: the front plate (2) is provided with a large front rail (22), and the large front rail (22) is provided with a front large plate pad (23) and a front plate buckle (24), and the front large plate pad (23) is used to support the main body of the car cover.

14. The embedded hard cover according to claims 1, 2, 6, and 7, characterized in that it further comprises a buckle component, which comprises a buckle (91), a webbing (92), and a buckle seat (93). One end of the webbing (92) is connected to the buckle (91), and the other end of the webbing (92) is provided with a webbing binding ring (9201). The buckle seat (93) is connected to the plate body or the rotating shaft (1), and is provided with a fixed binding rod (9301) and a buckle fixing port (9302). The webbing binding ring (9201) is connected to the fixed binding rod (9301), and the buckle seat (93) is provided with a fixed binding rod (9301) and a buckle fixing port (9302). The buckle fixing port (9302) is compatible with the buckle (91).

15. The embedded hard cover according to claims 1, 2, 6, and 7, characterized in that: the middle plate (3) is connected with a plastic buckle (31), the guide rail system (6) is provided with a guide rail plastic hook block (63), the vehicle side rail is connected with a side rail clip (69), and the side rail clip (69) is provided with a guide rail plastic hook block (63), and the plastic buckle (31) and the side rail clip (69) rotate and cooperate.

16. An embedded hard cover, characterized by: comprising a rotating shaft (1), edge strip (5), guide rail system (6), clip system (7), and multiple plate bodies;
The multiple plates are connected to each other through a rotating shaft (1);
The edge strip (5) is connected to both ends of the rotating shaft (1) and the plate body, and the rotating shaft (1), the plate body, and the edge strip (5) form the main body of the lid;
The guide rail system (6) is used to support the cover body, and the clip system (7) is used to fix the guide rail system (6) on the vehicle body. The guide rail system (6) includes a guide rail, which is provided with a guide rail upper plane (6101) and a guide rail lower plane (6102);
The front plate (2) comprises a front panel side rail (26), which is provided with a support edge (2603) supported on the guide rail upper plane (6101) of the guide rail. There is a gap (2605) between the front panel side rail (26) and the 1 guide rail lower plane (6102) of the guide rail.
